(19) United States
(12) Patent Application Publication
(10) Pub. No.: US 2013/0298540 A1
(43) Pub. Date: Nov. 14, 2013

(54) Closed-cycle hydro-jet thruster

(71) Applicant: ESSAM TAWFIK MARCUS, Morrisville, NC (US)

(72) Inventor: ESSAM TAWFIK MARCUS, Morrisville, NC (US)

(21) Appl. No.: 13/466,975

(22) Filed: May 8, 2012

(51) Int. Cl. F16D 31/00

(52) U.S. Cl. 60/325

(57) ABSTRACT

The present invention provides closed-cycle hydro jet thruster (CCHJT) used for the direct conversion of torque into thrust and/or lift force. In a preferred embodiment, the CCHJT includes an outer casing; two inner-members; an intermediate body; a plurality of convergent nozzles; a set of intersecting members; a drive shaft; a rotor assembly having a plurality of blades; a hydraulic fluid completely filling the space within the casing; and a fluid pressure regulating system. In operation, the rotating blades accelerate and compress the hydraulic fluid leading to generation of thrust/lift force on the blades, which is transmitted to the CCHJT's casing through thrust bearings. This is followed by acceleration of the working fluid within the nozzles, suddenly expanding the accelerated working fluid within sub-passages defined in-between the intersecting members, and then directing the flow of the working fluid towards the upstream suction surfaces of the blades for re-acceleration.

### TECHNICAL FIELD

The present invention relates to a closed-cycle hydro jet thruster (CCHJT), and more particularly to a direct Torque-to-Thrust conversion device which is used for converting therein the torque provided by a prime mover, or an electric motor, into direct thrust, or lift, force, with said generated thrust, or lift, force being used directly for propelling, or lifting, a movable vehicle.

### BACKGROUND ART

Direct Torque-to-Thrust conversion mechanisms having rotating cascades of blades that interact with a surrounding fluid medium to generate thrust/lift force are well known in the Art; with non-limiting examples of such mechanisms including aircraft and ship propellers, and open-cycle hydro jet propulsion devices. In these mechanisms, the torque provided by a prime mover or an electric motor is used in rotating a number of blades leading to acceleration of a fluid medium downstream of the blades and generation of an opposing reaction force on the rotating blades, with said generated opposing reaction force being used in propelling the aircraft or the ship. The accelerated working fluid (air or water) decelerates downstream of the blades with ultimate conversion of its kinetic energy into heat energy which dissipates to surrounding atmosphere.

However, as the before mentioned direct Torque-to-Thrust conversion mechanisms utilize the fluid medium around the propelled vehicle as their working fluid, so the amount of thrust generated by their blades depends on the relative speed between the moving vehicle and the speed with which the working fluid is being accelerated by the rotating blades. This necessitates using blades having relatively high angles of attack, or coarse pitches, which decreases the Torque-to-Thrust conversion ratios provided by these direct Torque-to-Thrust conversion mechanisms.

In addition, as these conventional direct Torque-to-Thrust conversion mechanisms utilize the surrounding fluid as their working medium, so this limits their use for propelling land vehicles to Hovercrafts and the like, which are not practical for city use due to several operational limitations, and due to their low overall Torque-to-Thrust conversion ratio.

The use of properly shaped air/hydrofoils, operating at relatively low angles of attack, i.e. angles of attack lying within a range between −2° and +14°, for the efficient generation of lift force on the wings of airplanes, the rotor blades of helicopters, and hydrofoils are also well known in the Art, with Lift/Drag ratios ranging between 10/1 and 65/1 being attainable. However, applying the same principal for the efficient conversion of the torque provided by a prime mover, or a motor, into a thrust force, using a rotating cascade of blades having relatively low angles of attack and operating within an open system is not described in prior Art due to the marked drop in the efficiency of the thrust force generated by low angle of attack air/hydrofoils when operating in non-stagnant upstream working fluid conditions.

And thus, in spite of the well known high efficiency of properly designed, low angle of attack air/hydrofoils in generating lift force, yet, their use for the efficient generation of thrust force to drive land, sea and air vehicles has been hindered by the before-mentioned limiting factors.

### BRIEF SUMMARY OF THE INVENTION

The present invention provides a closed-cycle hydro jet thruster (CCHJT) that includes a rotating cascade of blades having relatively low angles of attack, and directly interacting with a fluid medium completely enclosed within the CCHJT's casing, to generate thrust/lift force, with said generated force being used for propelling, or lifting, a movable vehicle.

The present invention also provides a CCHJT that can be used for propelling all types of land, sea and air vehicles, and which enables providing high Power-to-Thrust conversion ratios regardless of the cruising speed of the propelled vehicle.

As used hereinafter, the term “angle of attack” refers to the angle between the chord line of a blade and the vector representing the relative motion between the blade and a working fluid; and the term “low angle of attack” refers to and includes any angle of attack lying within the range between 2° and 14°.

Accordingly, the present invention provides a closed-cycle hydro jet thruster (CCHJT) which is used for converting therein the torque provided by a prime mover, or an electric motor, into direct thrust and/or lift force, with said generated thrust and/or lift force being used directly for propelling and/or lifting a movable vehicle, and with the said CCHJT comprising: a non-rotating component that is configured to define at least one closed-circuit fluid flow passage therewithin, and that includes at least one set of convergent nozzles, and at least one set of intersecting members configured to divide a part of the said at least one fluid flow passage into a number of sub-passages; a hydraulic fluid completely filling the said at least one closed-circuit fluid flow passage; and a rotating component that includes a rotor having a plurality of circumferentially arranged blades, with the said blades being positioned for rotation within the said at least one closed-circuit fluid flow passage, oriented to rotate in a plane normal to the direction in which force is generated during operation, and configured to operate at low angles of attack, the said at least one set of convergent nozzles is positioned downstream of the said blades and configured to accelerate the fluid flowing through them during operation, leading to conversion of a part of the hydrostatic energy of the hydraulic fluid displaced downstream of the said blades into kinetic energy, and the said at least one set of intersecting members is positioned downstream of the said convergent nozzles, with the said sub-passages defined in-between the said intersecting members being configured to suddenly expand the fluid flowing out of the said convergent nozzles during operation, leading to conversion of a part of its kinetic energy into heat energy.

In a preferred embodiment, the CCHJT comprises: a non-rotating component fixedly attached to the chassis of a propelled vehicle and includes: a generally oval-shaped outer casing portion having a longitudinal axis that is oriented in alignment with the direction of movement of the vehicle; at least two inner member portions fixedly attached against rotation to the outer casing portion; at least one intermediate body portion fixedly attached against rotation to the outer casing portion and located intermediate of the outer casing portion and the at least two inner member portions, with the opposing surfaces of the at least two inner member portions and the at least one intermediate body portion defining a central fluid flow passage there in-between, and the opposing surfaces of the at least one intermediate body portion and the outer casing portion defining a peripheral fluid flow passage there in-between, the central fluid flow passage has a fluid inflow end and a fluid outflow end, and the peripheral fluid flow passage has a fluid inflow end and a fluid outflow end, with the fluid outflow end of the central fluid flow passage merging with the fluid inflow end of the peripheral fluid flow passage, and with the fluid outflow end of the peripheral fluid flow passage merging with the fluid inflow end of the central fluid flow passage to form a closed fluid circuit within the thruster; a plurality of radially-oriented planar members positioned within the peripheral fluid flow passage, the radially-oriented planar members are fixedly attached against rotation to at least one of the said portions of the non-rotating component that define the peripheral fluid flow passage between them, and configured to divide the peripheral fluid flow passage into a plurality of sub-passages, each radially-oriented planar member has a first end partially extending within the fluid outflow end of the central fluid flow passage and a second end partially extending within the fluid inflow end of the central fluid flow passage; a plurality of convergent nozzles positioned within the central fluid flow passage in proximity to the fluid inflow end of the said passage and fixedly attached against rotation to at least one of the said portions of the non-rotating component that define the central fluid flow passage between them; and at least one set of intersecting members positioned within the central fluid flow passage downstream of the said convergent nozzles, the at least one set of intersecting members is fixedly attached against rotation to at least one of the said portions of the non-rotating component that define the central fluid flow passage between them, includes a plurality of radially-oriented planar members intersecting with at least one annular cylinder member, and is configured to divide a part of the central fluid flow passage downstream of the said convergent nozzles into a plurality of sub-passages; a drive shaft supported for rotation in a given direction inside the outer casing by an arrangement of bearings and having a longitudinal axis coinciding with the said longitudinal axis of the outer casing; a rotor secured for rotation with the drive shaft and lying in a plane normal to the longitudinal axis of the drive shaft, said rotor includes at least one central disk and a plurality of circumferentially arranged blades, each blade has an inner edge attached to the central disk, an outer edge, a leading edge, and a trailing edge, with said blades being positioned for rotation within the said central fluid flow passage; a hydraulic fluid completely filling the said fluid flow passages and the free spaces enclosed within the said outer casing portion of the non-rotating component; and a fluid pressure regulating system.

In operation, the rotating rotor blades will compress and displace the hydraulic fluid downstream of the blades, and create a low-pressure zone upstream of the blades leading to suction of the hydraulic fluid towards the blades. The developed pressure gradient between the upstream and downstream surfaces of the blades, along with the displacement of the working fluid downstream of the blades will lead to the generation of linear force acting in a direction perpendicular to the plane of rotation of the blades, with said generated linear force being used directly for propelling and/or lifting a movable vehicle. As the blades are configured to operate at relatively low angles of attack, so most of the generated linear force by the rotating blades will be due to the pressure gradient between the upstream and downstream surfaces of the blades, with only a small fraction of that force being due to the displacement of the hydraulic fluid downstream of the blades.

The portion of the central fluid flow passage downstream of the blades is configured to allow for merging of the separate sub-flows of hydraulic fluid displaced downstream of the blades into one common flow having homogenous hydrostatic pressure and velocity, followed by splitting the flow into a number of sub-flows each directed towards one of the said peripheral sub-passages confined between the said outer casing, the said intermediate body portion, and the said radially-oriented planar members, with the peripheral sub-passages being configured to direct the flow of the working fluid from the downstream end of the central fluid flow passage to the upstream end of the central fluid flow passage. On reaching the upstream end of the central fluid flow passage, each of the fluid sub-flows will be directed through a number of the said nozzles positioned within the central fluid flow passage, wherein the working fluid accelerates with partial conversion of its hydrostatic energy into kinetic energy. The accelerated working fluid will be then directed through the sub-passages formed in-between the said at least one set of intersecting members, with the said sub-passages being configured to suddenly expand the working fluid flowing out of the convergent nozzles. The sudden expansion of the working fluid leads to conversion of a part of its kinetic energy into heat energy, with said heat energy being eventually dissipated through the outer casing of the CCHJT to the surrounding atmosphere.

The portion of the central fluid flow passage upstream of the blades is configured to first align the flow of the decelerated working fluid flowing out of the said sub-passages, and then to direct the flow of the working fluid towards the suction surfaces of the rotating blades where the working fluid is re-accelerated by the effect of the low pressure zone created upstream of the blades during operation.

The number of the blades of the CCHJT rotor ranges preferably between 6 and 72 blades, depending on the size of the CCHJT and amount of thrust, or lift, force to be generated. In a preferred embodiment, each two successive blades are separated by an intervening gap to minimize the interaction between successive blades during operation, with the ratio between the mean width of each of the said intervening gaps and the mean Chord length of each of the blades (the Gap/Blade ratio or G/B ratio) being determined according to the desired degree of deceleration of the working fluid downstream of the blades, noting that the degree of deceleration will be proportional to the G/B ratio. In a preferred embodiment, the G/B ratio lies preferably anywhere within a range between 0.25:1 and 2:1, and more preferably between 0.5:1 and 1:1.

The successive parts of each of the rotor blades are either designed with the same angle of attack, or designed with gradually increasing angles of attack from the blade's outer edge to the blade's inner edge, so that the downstream flow of the working fluid will be homogenized in terms of total pressure. Accordingly, in a preferred embodiment the angle of attack, or the angles of attacks of the successive parts of each blade, is/are selected from a range of angles lying anywhere between 2 degrees and 14 degrees, and in a more preferred embodiment, the angle(s) of attack is/are selected from a range of angles lying anywhere between 4 degrees and 10 degrees. Such design considerations are well known by people experienced in the Art.

In a preferred embodiment, each of the said blades of the rotor has a suction surface and a displacing surface, with the displacing surface being geometrically formed of two successive merging portions, a first portion having a leading end coinciding with the leading edge of the blade and a trailing end and a second portion having a leading end and a trailing end coinciding with the trailing edge of the blade, the said first portion extends from the said leading edge of the blade to the said leading end of the second portion and is generally concave when viewed in cross-sectional profile, and the said second portion extends from the said trailing end of the first portion to the said trailing edge of the blade and is generally convex when viewed in cross-sectional profile.

In another preferred embodiment, each of the said blades of the rotor has a suction surface and a displacing surface, with the displacing surface being geometrically formed of three successive merging portions, a first portion having a leading end coinciding with the leading edge of the blade and a trailing end, a second portion having a leading end and a trailing end, and a third portion having a leading end and a trailing end coinciding with the trailing edge of the blade, the said first portion extends from the said leading edge of the blade to the said leading end of the second portion and is generally concave when viewed in cross-sectional profile, the said second portion extends from the said trailing end of the first portion to the said leading end of the third portion and is generally convex when viewed in cross-sectional profile, and the said third portion extends from the said trailing end of the second portion to the said trailing edge of the blade and is generally concave when viewed in cross-sectional profile.

In a preferred embodiment, each of the said blades of the rotor has a beak-like leading edge when viewed in cross-sectional profile, to disrupt the eddies formed due to the interaction between successive blades during operation. In another preferred embodiment, each of the said blades of the rotor has a downstream curved trailing edge when viewed in cross-sectional profile, to increase the hydrostatic pressure of the working fluid downstream the blades during operation and improve the blade's overall performance.

In a preferred embodiment, the said rotor further includes a circumferential, cylinder-shaped shroud positioned around the outer edges of the said rotor blades and has an inner surface and an outer surface, with the inner surface of the said shroud being attached to the outer edges of the said rotor blades to minimize/prevent the development of vortices around the outer edges of the blades during operation.

In a preferred embodiment, the said at least one set of intersecting members positioned downstream of the convergent nozzles includes a plurality of radially-oriented planar members intersecting with more than one concentric annular cylinder members, with the at least one set of intersecting members being configured to divide a part of the central fluid flow passage downstream of the said convergent nozzles into a plurality of sub-passages. In another preferred embodiment, the said at least one set of intersecting members positioned downstream of the convergent nozzles comprises two axially stacked sets of intersecting members: a first set of intersecting members and a second set of intersecting members, with the second set of intersecting members positioned downstream of the first set of intersecting members, and with the said non-rotating component of the thruster further includes a set of concentric, fluid flow directing, annular members positioned within the central fluid flow passage in-between the said two axially stacked sets of intersecting members and fixedly attached against rotation to at least one of the said portions of the non-rotating component that define the central fluid flow passage between them, each of the said sets of intersecting members is fixedly attached against rotation to at least one of the said portions of the non-rotating component that define the central fluid flow passage between them, includes a plurality of radially-oriented planar members intersecting with at least one annular cylinder member, and is configured to divide a part of the central fluid flow passage downstream of the convergent nozzles into a plurality of sub-passages, the said set of concentric, fluid flow directing, annular members is configured so that the opposing surfaces of its concentric annular members along with the related parts of the surfaces of the at least one intermediate body portion and the at least two inner member portions define a plurality of concentric fluid flow passages for directing the flow of a working fluid from the said sub-passages defined by the first set of intersecting members to the said sub-passages defined by the second set of intersecting members. In a preferred embodiment, at least one of the two axially stacked sets of intersecting members positioned downstream of the convergent nozzles includes a plurality of radially-oriented planar members intersecting with more than one concentric annular cylinder members, with the at least one of the two axially stacked sets of intersecting members being configured to divide a part of the central fluid flow passage downstream of the convergent nozzles into a plurality of sub-passages.

The rotor may be manufactured as a whole by forging or casting, or, the central disk of the rotor is forged or casted separately, with each blade, or each group of blades, being forged or casted separately, followed by assembling the rotor. Such manufacturing and assembling techniques are also well known by people experienced in the Art.

To increase the Thrust/Lift-to-weight ratio of the CCHJT during operation, the CCHJT rotor blades are operate at relatively high operating speeds, at which cavitations are expected to form on the upstream suction surfaces of the blades. To enable operating the blades at relatively high operating speeds without the formation of cavitations on the upstream suction surfaces of the blades, the hydraulic fluid filling the fluid flow passages and the free spaces enclosed within the CCHJT casing is maintained during operation at a pressure level higher than ambient pressure level, aided by the before mentioned fluid pressure regulating system.

In a preferred embodiment, the said fluid pressure regulating system comprises a fluid reservoir partially filled with a hydraulic fluid; a hydraulic pump having an inlet and an outlet, with the said hydraulic pump inlet being fluidly coupled to the said fluid reservoir; a unidirectional valve having an inlet port fluidly coupled to the said hydraulic pump outlet and an outlet fluidly coupled to at least one of the said fluid flow passages defined within the CCHJT, and configured to permit fluid flow only in one direction from the hydraulic pump outlet to the said at least one of the fluid flow passages defined within the CCHJT; a spring-loaded safety relief valve having an inlet port fluidly coupled to at least one of the said fluid flow passages defined within the CCHJT and an outlet port fluidly coupled to the said fluid reservoir, and configured to permit fluid flow only in one direction from the said at least one of the said fluid flow passages defined within the CCHJT to the said fluid reservoir once a first predetermined hydrostatic pressure is reached within the CCHJT; and a spring-loaded suction valve having an inlet port fluidly coupled to the said fluid reservoir and an outlet port fluidly coupled to at least one of the said fluid flow passages defined within the CCHJT, and configured to permit fluid flow only in one direction from the said fluid reservoir to the said at least one of the said fluid flow passages defined within the CCHJT once a second predetermined hydrostatic pressure is reached within the CCHJT. In a preferred embodiment, the said fluid reservoir is completely sealed from surrounding atmosphere. In another preferred embodiment, the said fluid reservoir has at least one passage for connecting it with surrounding ambient air.

In a preferred embodiment, the said fluid reservoir has at least one spring-loaded safety relief valve having an inlet port fluidly coupled to a gas filled space confined within the said fluid reservoir and an outlet port fluidly coupled to surrounding ambient air, and configured to permit gas flow only in one direction from the said fluid reservoir to surrounding ambient air once a first predetermined pressure is reached within the said fluid reservoir; and at least one spring-loaded suction valve, having an inlet port fluidly coupled to surrounding ambient air and an outlet valve fluidly coupled to a gas filled space confined within the said fluid reservoir, and configured to permit gas flow only in one direction from the surrounding ambient air to the said fluid reservoir once a second predetermined pressure is reached within the said fluid reservoir. Such arrangements are well known by people experienced in the Art.

In a preferred embodiment, at least one arrangement for dissipating the heat generated within the said CCHJT during operation is provided. In a preferred embodiment, the said arrangement provided for dissipating the heat generated within the CCHJT during operation includes a plurality of cooling ribs provided on the outer surface of the said outer casing portion of the non-rotating component of the CCHJT. In another preferred embodiment, the said arrangement provided for dissipating the heat generated within the CCHJT during operation includes a forced air or a forced fluid cooling mechanism. In yet another preferred embodiment, the said arrangement provided for dissipating the heat generated within the CCHJT during operation is configured to employ the discharged heat in heating a fluid medium flowing around the CCHJT. Such arrangements are well known by people experienced in the Art.

In a preferred embodiment, the said thrust, or lift, force generated by the said blades of the rotor during operation is transmitted to the said non-rotating component of the CCHJT through at least one thrust bearing arrangement, with non-limiting examples of thrust bearing arrangements for use including fixed-geometry thrust bearings; and tilting pad thrust bearings.

In a preferred embodiment, the said drive shaft extends to a drive-receiving end located outside the casing, through which driving torque is supplied during operation. In another preferred embodiment, the drive shaft is geared to another intermediate shaft, with the said intermediate shaft extending to a drive-receiving end located outside the casing, through which driving torque is supplied during operation. Such arrangements are well known by people experienced in the Art.

In a preferred embodiment, the driving torque for the CCHJT's shaft is provided by an engine, with the torque supplied by the engine being transmitted to the CCHJT's drive shaft either directly or indirectly through a gear train arrangement. In another preferred embodiment, the driving torque for the CCHJT's shaft is provided by an electric motor, with the torque supplied by it being transmitted to the CCHJT's drive shaft either directly, or indirectly through gear train arrangement, and with the electric motor's driving electric current being supplied from: at least one rechargeable electricity storage system, e.g. an electric battery or an ultra-capacitor; a fuel cell; an electric generator driven by a prime mover; or any combination thereof.

In a preferred embodiment, an even number of CCHJTs are used, with the CCHJTs being arranged in one or more pairs, and with each pair of CCHJTs being designed with counter-rotating rotors, to balance out the torque effect developed by their rotating components during operation.

In a preferred embodiment, the CCHJT is fixedly attached to the main frame of the propelled vehicle. In another preferred embodiment, the CCHJT is pivotally attached to the main frame of the propelled vehicle, with at least one mechanism for changing the direction in which the developed thrust/lift force is applied being provided, to enable changing the direction of the developed thrust/lift force during operation. Such arrangements are also well known by people experienced in the Art.

The present invention also provides an operating cycle for use in a CCHJT, with the said CCHJT having: a non-rotating component that is configured to define at least one closed-circuit fluid flow passage therewithin, and that includes at least one set of convergent nozzles, and at least one set of intersecting members configured to divide a part of the said at least one fluid flow passage into a number of sub-passages; a hydraulic fluid completely filling the said at least one closed-circuit fluid flow passage; and a rotating component that includes a rotor having a plurality of circumferentially arranged blades positioned for rotation within the said at least one closed-circuit fluid flow passage and configured to operate at low angles of attack, and with the said operating cycle including the steps of:

a. compressing and displacing the said hydraulic fluid downstream of the said blades;

b. accelerating the said compressed, displaced working fluid by flowing it through the said at least one set of convergent nozzles; and

c. suddenly expanding the said accelerated working fluid by flowing it through the said sub-passages defined in-between the said at least one set of intersecting members.

In a preferred embodiment, the operating cycle of the CCHJT further includes the step of:

d. actively dissipating the heat generated within the closed-cycle hydro jet thruster during operation to a surrounding atmosphere.

### BRIEF DESCRIPTION OF DRAWINGS

The description of the objects, features and advantages of the present invention, will be more fully appreciated by reference to the following detailed description of the exemplary embodiments in accordance with the accompanying drawings, wherein:

FIG. 1 is a sectional view in a schematic representation of an exemplary embodiment of a closed-cycle hydro jet thruster (CCHJT), in accordance with the present invention.

FIG. 2 is a cross sectional view, taken at the plane of line 2-2 in FIG. 1.

FIG. 3 is a cross sectional view, taken at the plane of line 3-3 in FIG. 1.

FIG. 4 is a cross sectional view, taken at the plane of line 4-4 in FIG. 1.

FIG. 5 is a cross sectional view, taken at the plane of line 5-5 in FIG. 1.

FIG. 6 is a cross sectional view, taken at the plane of line 6-6 in FIG. 1.

FIG. 7 is a cross sectional view, taken at the plane of line 7-7 in FIG. 1.

FIG. 8 is a cross-sectional profile view in a schematic representation of a preferred embodiment of a blade for use in the CCHJT's rotor, in accordance with the present invention.

FIG. 9 is a cross-sectional profile view in a schematic representation of another preferred embodiment of a blade for use in the CCHJT's rotor, in accordance with the present invention.

FIG. 10 is a cross-sectional profile view in a schematic representation of another preferred embodiment of a blade for use in the CCHJT's rotor, in accordance with the present invention.

FIG. 11 is a sectional view in a schematic representation of another exemplary embodiment of a CCHJT, showing the components of a preferred embodiment of a fluid pressure regulating system, in accordance with the present invention.

FIG. 12 is a schematic representation of an exemplary embodiment of a CCHJT-driving mechanism layout within a driven vehicle, in accordance with the present invention.

FIG. 13 is an illustrative representation of the fluid flow cycle within a CCHJT, showing the energy added to, and discharged from, the hydraulic fluid during operation, in accordance with the present invention.

FIG. 14 is an illustrative representation of the forces generated on the rotating components of an exemplary embodiment of a CCHJT during operation, in accordance with the present invention.

FIG. 15 is an illustrative representation of the forces generated on the non-rotating components of an exemplary embodiment of a CCHJT during operation, in accordance with the present invention.

### DETAILED DESCRIPTION OF THE INVENTION

The present invention provides a closed-cycle hydro jet thruster (CCHJT) that includes a rotating cascade of blades having relatively low angles of attack, and directly interacting with a fluid medium completely enclosed within the CCHJT's casing, to generate thrust/lift force, with said generated force being used for propelling, or lifting, a movable vehicle.

The present invention also provides a CCHJT that can be used for propelling all types of land, sea and air vehicles, and which enables providing high Power-to-Thrust conversion ratios regardless of the cruising speed of the propelled vehicle.

As used hereinafter, the term “angle of attack” refers to the angle between the chord line of a blade and the vector representing the relative motion between the blade and a working fluid; and the term “low angle of attack” refers to and includes any angle of attack lying within the range between 2° and 14°.

Accordingly, the present invention provides a closed-cycle hydro jet thruster (CCHJT) which is used for converting therein the torque provided by a prime mover, or an electric motor, into direct thrust and/or lift force, with said generated thrust and/or lift force being used directly for propelling and/or lifting a movable vehicle, and with the said CCHJT comprising: a non-rotating component that is configured to define at least one closed-circuit fluid flow passage therewithin, and that includes at least one set of convergent nozzles, and at least one set of intersecting members configured to divide a part of the said at least one fluid flow passage into a number of sub-passages; a hydraulic fluid completely filling the said at least one closed-circuit fluid flow passage; and a rotating component that includes a rotor having a plurality of circumferentially arranged blades, with the said blades being positioned for rotation within the said at least one closed-circuit fluid flow passage, oriented to rotate in a plane normal to the direction in which force is generated during operation, and configured to operate at low angles of attack, the said at least one set of convergent nozzles is positioned downstream of the said blades and configured to accelerate the fluid flowing through them during operation, leading to conversion of a part of the hydrostatic energy of the hydraulic fluid displaced downstream of the said blades into kinetic energy, and the said at least one set of intersecting members is positioned downstream of the said convergent nozzles, with the said sub-passages defined in-between the said intersecting members being configured to suddenly expand the fluid flowing out of the said convergent nozzles during operation, leading to conversion of a part of its kinetic energy into heat energy.

In a preferred embodiment, the CCHJT comprises: a non-rotating component fixedly attached to the chassis of a propelled vehicle and includes: a generally oval-shaped outer casing portion having a longitudinal axis that is oriented in alignment with the direction of movement of the vehicle; at least two inner member portions fixedly attached against rotation to the outer casing portion; at least one intermediate body portion fixedly attached against rotation to the outer casing portion and located intermediate of the outer casing portion and the at least two inner member portions, with the opposing surfaces of the at least two inner member portions and the at least one intermediate body portion defining a central fluid flow passage there in-between, and the opposing surfaces of the at least one intermediate body portion and the outer casing portion defining a peripheral fluid flow passage there in-between, the central fluid flow passage has a fluid inflow end and a fluid outflow end, and the peripheral fluid flow passage has a fluid inflow end and a fluid outflow end, with the fluid outflow end of the central fluid flow passage merging with the fluid inflow end of the peripheral fluid flow passage, and with the fluid outflow end of the peripheral fluid flow passage merging with the fluid inflow end of the central fluid flow passage to form a closed fluid circuit within the thruster; a plurality of radially-oriented planar members positioned within the peripheral fluid flow passage, the radially-oriented planar members are fixedly attached against rotation to at least one of the said portions of the non-rotating component that define the peripheral fluid flow passage between them, and configured to divide the peripheral fluid flow passage into a plurality of sub-passages, each radially-oriented planar member has a first end partially extending within the fluid outflow end of the central fluid flow passage and a second end partially extending within the fluid inflow end of the central fluid flow passage; a plurality of convergent nozzles positioned within the central fluid flow passage in proximity to the fluid inflow end of the said passage and fixedly attached against rotation to at least one of the said portions of the non-rotating component that define the central fluid flow passage between them; and at least one set of intersecting members positioned within the central fluid flow passage downstream of the said convergent nozzles, the at least one set of intersecting members is fixedly attached against rotation to at least one of the said portions of the non-rotating component that define the central fluid flow passage between them, includes a plurality of radially-oriented planar members intersecting with at least one annular cylinder member, and is configured to divide a part of the central fluid flow passage downstream of the said convergent nozzles into a plurality of sub-passages; a drive shaft supported for rotation in a given direction inside the outer casing by an arrangement of bearings and having a longitudinal axis coinciding with the said longitudinal axis of the outer casing; a rotor secured for rotation with the drive shaft and lying in a plane normal to the longitudinal axis of the drive shaft, said rotor includes at least one central disk and a plurality of circumferentially arranged blades, each blade has an inner edge attached to the central disk, an outer edge, a leading edge, and a trailing edge, with said blades being positioned for rotation within the said central fluid flow passage; a hydraulic fluid completely filling the said fluid flow passages and the free spaces enclosed within the said outer casing portion of the non-rotating component; and a fluid pressure regulating system.

In operation, the rotating rotor blades will compress and displace the hydraulic fluid downstream of the blades, and create a low-pressure zone upstream of the blades leading to suction of the hydraulic fluid towards the blades. The developed pressure gradient between the upstream and downstream surfaces of the blades, along with the displacement of the working fluid downstream of the blades will lead to the generation of linear force acting in a direction perpendicular to the plane of rotation of the blades, with said generated linear force being used directly for propelling and/or lifting a movable vehicle. As the blades are configured to operate at relatively low angles of attack, so most of the generated linear force by the rotating blades will be due to the pressure gradient between the upstream and downstream surfaces of the blades, with only a small fraction of that force being due to the displacement of the hydraulic fluid downstream of the blades.

The portion of the central fluid flow passage downstream of the blades is configured to allow for merging of the separate sub-flows of hydraulic fluid displaced downstream of the blades into one common flow having homogenous hydrostatic pressure and velocity, followed by splitting the flow into a number of sub-flows each directed towards one of the said peripheral sub-passages confined between the said outer casing, the said intermediate body portion, and the said radially-oriented planar members, with the peripheral sub-passages being configured to direct the flow of the working fluid from the downstream end of the central fluid flow passage to the upstream end of the central fluid flow passage. On reaching the upstream end of the central fluid flow passage, each of the fluid sub-flows will be directed through a number of the said nozzles positioned within the central fluid flow passage, wherein the working fluid accelerates with partial conversion of its hydrostatic energy into kinetic energy. The accelerated working fluid will be then directed through the sub-passages formed in-between the said at least one set of intersecting members, with the said sub-passages being configured to suddenly expand the working fluid flowing out of the convergent nozzles. The sudden expansion of the working fluid leads to conversion of a part of its kinetic energy into heat energy, with said heat energy being eventually dissipated through the outer casing of the CCHJT to the surrounding atmosphere.

The portion of the central fluid flow passage upstream of the blades is configured to first align the flow of the decelerated working fluid flowing out of the said sub-passages, and then to direct the flow of the working fluid towards the suction surfaces of the rotating blades where the working fluid is re-accelerated by the effect of the low pressure zone created upstream of the blades during operation.

The number of the blades of the CCHJT rotor ranges preferably between 6 and 72 blades, depending on the size of the CCHJT and amount of thrust, or lift, force to be generated. In a preferred embodiment, each two successive blades are separated by an intervening gap to minimize the interaction between successive blades during operation, with the ratio between the mean width of each of the said intervening gaps and the mean Chord length of each of the blades (the Gap/Blade ratio or G/B ratio) being determined according to the desired degree of deceleration of the working fluid downstream of the blades, noting that the degree of deceleration will be proportional to the G/B ratio. In a preferred embodiment, the G/B ratio lies preferably anywhere within a range between 0.25:1 and 2:1, and more preferably between 0.5:1 and 1:1.

The successive parts of each of the rotor blades are either designed with the same angle of attack, or designed with gradually increasing angles of attack from the blade's outer edge to the blade's inner edge, so that the downstream flow of the working fluid will be homogenized in terms of total pressure. Accordingly, in a preferred embodiment the angle of attack, or the angles of attacks of the successive parts of each blade, is/are selected from a range of angles lying anywhere between 2 degrees and 14 degrees, and in a more preferred embodiment, the angle(s) of attack is/are selected from a range of angles lying anywhere between 4 degrees and 10 degrees. Such design considerations are well known by people experienced in the Art.

In a preferred embodiment, each of the said blades of the rotor has a suction surface and a displacing surface, with the displacing surface being geometrically formed of two successive merging portions, a first portion having a leading end coinciding with the leading edge of the blade and a trailing end and a second portion having a leading end and a trailing end coinciding with the trailing edge of the blade, the said first portion extends from the said leading edge of the blade to the said leading end of the second portion and is generally concave when viewed in cross-sectional profile, and the said second portion extends from the said trailing end of the first portion to the said trailing edge of the blade and is generally convex when viewed in cross-sectional profile.

In another preferred embodiment, each of the said blades of the rotor has a suction surface and a displacing surface, with the displacing surface being geometrically formed of three successive merging portions, a first portion having a leading end coinciding with the leading edge of the blade and a trailing end, a second portion having a leading end and a trailing end, and a third portion having a leading end and a trailing end coinciding with the trailing edge of the blade, the said first portion extends from the said leading edge of the blade to the said leading end of the second portion and is generally concave when viewed in cross-sectional profile, the said second portion extends from the said trailing end of the first portion to the said leading end of the third portion and is generally convex when viewed in cross-sectional profile, and the said third portion extends from the said trailing end of the second portion to the said trailing edge of the blade and is generally concave when viewed in cross-sectional profile.

In a preferred embodiment, each of the said blades of the rotor has a beak-like leading edge when viewed in cross-sectional profile, to disrupt the eddies formed due to the interaction between successive blades during operation. In another preferred embodiment, each of the said blades of the rotor has a downstream curved trailing edge when viewed in cross-sectional profile, to increase the hydrostatic pressure of the working fluid downstream the blades during operation and improve the blade's overall performance.

In a preferred embodiment, the said rotor further includes a circumferential, cylinder-shaped shroud positioned around the outer edges of the said rotor blades and has an inner surface and an outer surface, with the inner surface of the said shroud being attached to the outer edges of the said rotor blades to minimize/prevent the development of vortices around the outer edges of the blades during operation.

In a preferred embodiment, the said at least one set of intersecting members positioned downstream of the convergent nozzles includes a plurality of radially-oriented planar members intersecting with more than one concentric annular cylinder members, with the at least one set of intersecting members being configured to divide a part of the central fluid flow passage downstream of the said convergent nozzles into a plurality of sub-passages. In another preferred embodiment, the said at least one set of intersecting members positioned downstream of the convergent nozzles comprises two axially stacked sets of intersecting members: a first set of intersecting members and a second set of intersecting members, with the second set of intersecting members positioned downstream of the first set of intersecting members, and with the said non-rotating component of the thruster further includes a set of concentric, fluid flow directing, annular members positioned within the central fluid flow passage in-between the said two axially stacked sets of intersecting members and fixedly attached against rotation to at least one of the said portions of the non-rotating component that define the central fluid flow passage between them, each of the said sets of intersecting members is fixedly attached against rotation to at least one of the said portions of the non-rotating component that define the central fluid flow passage between them, includes a plurality of radially-oriented planar members intersecting with at least one annular cylinder member, and is configured to divide a part of the central fluid flow passage downstream of the convergent nozzles into a plurality of sub-passages, the said set of concentric, fluid flow directing, annular members is configured so that the opposing surfaces of its concentric annular members along with the related parts of the surfaces of the at least one intermediate body portion and the at least two inner member portions define a plurality of concentric fluid flow passages for directing the flow of a working fluid from the said sub-passages defined by the first set of intersecting members to the said sub-passages defined by the second set of intersecting members. In a preferred embodiment, at least one of the two axially stacked sets of intersecting members positioned downstream of the convergent nozzles includes a plurality of radially-oriented planar members intersecting with more than one concentric annular cylinder members, with the at least one of the two axially stacked sets of intersecting members being configured to divide a part of the central fluid flow passage downstream of the convergent nozzles into a plurality of sub-passages.

The rotor may be manufactured as a whole by forging or casting, or, the central disk of the rotor is forged or casted separately, with each blade, or each group of blades, being forged or casted separately, followed by assembling the rotor. Such manufacturing and assembling techniques are also well known by people experienced in the Art.

To increase the Thrust/Lift-to-weight ratio of the CCHJT during operation, the CCHJT rotor blades are operate at relatively high operating speeds, at which cavitations are expected to form on the upstream suction surfaces of the blades. To enable operating the blades at relatively high operating speeds without the formation of cavitations on the upstream suction surfaces of the blades, the hydraulic fluid filling the fluid flow passages and the free spaces enclosed within the CCHJT casing is maintained during operation at a pressure level higher than ambient pressure level, aided by the before mentioned fluid pressure regulating system.

In a preferred embodiment, the said fluid pressure regulating system comprises a fluid reservoir partially filled with a hydraulic fluid; a hydraulic pump having an inlet and an outlet, with the said hydraulic pump inlet being fluidly coupled to the said fluid reservoir; a unidirectional valve having an inlet port fluidly coupled to the said hydraulic pump outlet and an outlet fluidly coupled to at least one of the said fluid flow passages defined within the CCHJT, and configured to permit fluid flow only in one direction from the hydraulic pump outlet to the said at least one of the fluid flow passages defined within the CCHJT; a spring-loaded safety relief valve having an inlet port fluidly coupled to at least one of the said fluid flow passages defined within the CCHJT and an outlet port fluidly coupled to the said fluid reservoir, and configured to permit fluid flow only in one direction from the said at least one of the said fluid flow passages defined within the CCHJT to the said fluid reservoir once a first predetermined hydrostatic pressure is reached within the CCHJT; and a spring-loaded suction valve having an inlet port fluidly coupled to the said fluid reservoir and an outlet port fluidly coupled to at least one of the said fluid flow passages defined within the CCHJT, and configured to permit fluid flow only in one direction from the said fluid reservoir to the said at least one of the said fluid flow passages defined within the CCHJT once a second predetermined hydrostatic pressure is reached within the CCHJT. In a preferred embodiment, the said fluid reservoir is completely sealed from surrounding atmosphere. In another preferred embodiment, the said fluid reservoir has at least one passage for connecting it with surrounding ambient air.

In a preferred embodiment, the said fluid reservoir has at least one spring-loaded safety relief valve having an inlet port fluidly coupled to a gas filled space confined within the said fluid reservoir and an outlet port fluidly coupled to surrounding ambient air, and configured to permit gas flow only in one direction from the said fluid reservoir to surrounding ambient air once a first predetermined pressure is reached within the said fluid reservoir; and at least one spring-loaded suction valve, having an inlet port fluidly coupled to surrounding ambient air and an outlet valve fluidly coupled to a gas filled space confined within the said fluid reservoir, and configured to permit gas flow only in one direction from the surrounding ambient air to the said fluid reservoir once a second predetermined pressure is reached within the said fluid reservoir. Such arrangements are well known by people experienced in the Art.

In a preferred embodiment, at least one arrangement for dissipating the heat generated within the said CCHJT during operation is provided. In a preferred embodiment, the said arrangement provided for dissipating the heat generated within the CCHJT during operation includes a plurality of cooling ribs provided on the outer surface of the said outer casing portion of the non-rotating component of the CCHJT. In another preferred embodiment, the said arrangement provided for dissipating the heat generated within the CCHJT during operation includes a forced air or a forced fluid cooling mechanism. In yet another preferred embodiment, the said arrangement provided for dissipating the heat generated within the CCHJT during operation is configured to employ the discharged heat in heating a fluid medium flowing around the CCHJT. Such arrangements are well known by people experienced in the Art.

In a preferred embodiment, the said thrust, or lift, force generated by the said blades of the rotor during operation is transmitted to the said non-rotating component of the CCHJT through at least one thrust bearing arrangement, with non-limiting examples of thrust bearing arrangements for use including fixed-geometry thrust bearings; and tilting pad thrust bearings.

In a preferred embodiment, the said drive shaft extends to a drive-receiving end located outside the casing, through which driving torque is supplied during operation. In another preferred embodiment, the drive shaft is geared to another intermediate shaft, with the said intermediate shaft extending to a drive-receiving end located outside the casing, through which driving torque is supplied during operation. Such arrangements are well known by people experienced in the Art.

In a preferred embodiment, the driving torque for the CCHJT's shaft is provided by an engine, with the torque supplied by the engine being transmitted to the CCHJT's drive shaft either directly or indirectly through a gear train arrangement. In another preferred embodiment, the driving torque for the CCHJT's shaft is provided by an electric motor, with the torque supplied by it being transmitted to the CCHJT's drive shaft either directly, or indirectly through gear train arrangement, and with the electric motor's driving electric current being supplied from: at least one rechargeable electricity storage system, e.g. an electric battery or an ultra-capacitor; a fuel cell; an electric generator driven by a prime mover; or any combination thereof.

In a preferred embodiment, an even number of CCHJTs are used, with the CCHJTs being arranged in one or more pairs, and with each pair of CCHJTs being designed with counter-rotating rotors, to balance out the torque effect developed by their rotating components during operation.

In a preferred embodiment, the CCHJT is fixedly attached to the main frame of the propelled vehicle. In another preferred embodiment, the CCHJT is pivotally attached to the main frame of the propelled vehicle, with at least one mechanism for changing the direction in which the developed thrust/lift force is applied being provided, to enable changing the direction of the developed thrust/lift force during operation. Such arrangements are also well known by people experienced in the Art.

The present invention also provides an operating cycle for use in a CCHJT, with the said CCHJT having: a non-rotating component that is configured to define at least one closed-circuit fluid flow passage therewithin, and that includes at least one set of convergent nozzles, and at least one set of intersecting members configured to divide a part of the said at least one fluid flow passage into a number of sub-passages; a hydraulic fluid completely filling the said at least one closed-circuit fluid flow passage; and a rotating component that includes a rotor having a plurality of circumferentially arranged blades positioned for rotation within the said at least one closed-circuit fluid flow passage and configured to operate at low angles of attack, and with the said operating cycle including the steps of:

a. compressing and displacing the said hydraulic fluid downstream of the said blades;

b. accelerating the said compressed, displaced working fluid by flowing it through the said at least one set of convergent nozzles; and

c. suddenly expanding the said accelerated working fluid by flowing it through the said sub-passages defined in-between the said at least one set of intersecting members.

In a preferred embodiment, the operating cycle of the CCHJT further includes the step of:

d. actively dissipating the heat generated within the closed-cycle hydro jet thruster during operation to a surrounding atmosphere.

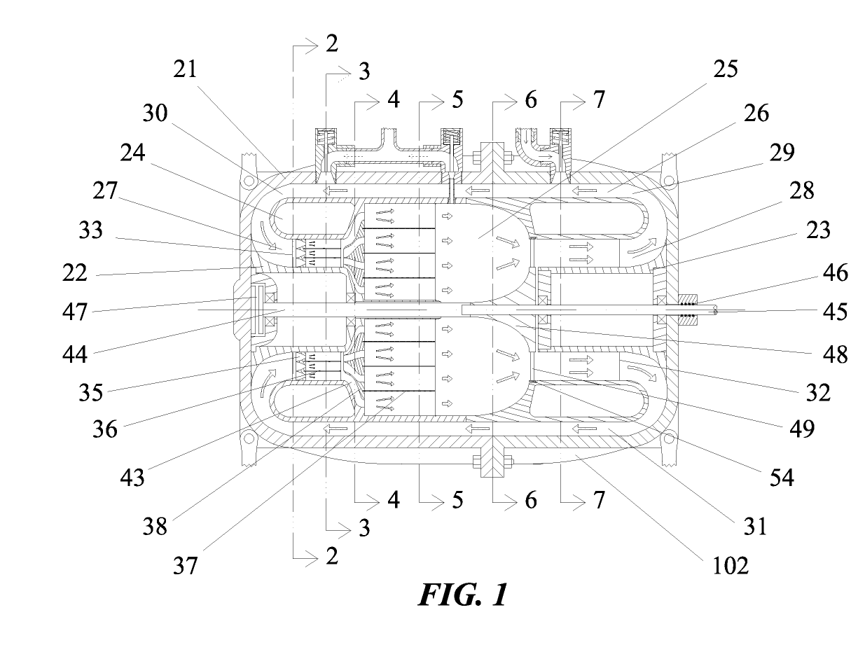

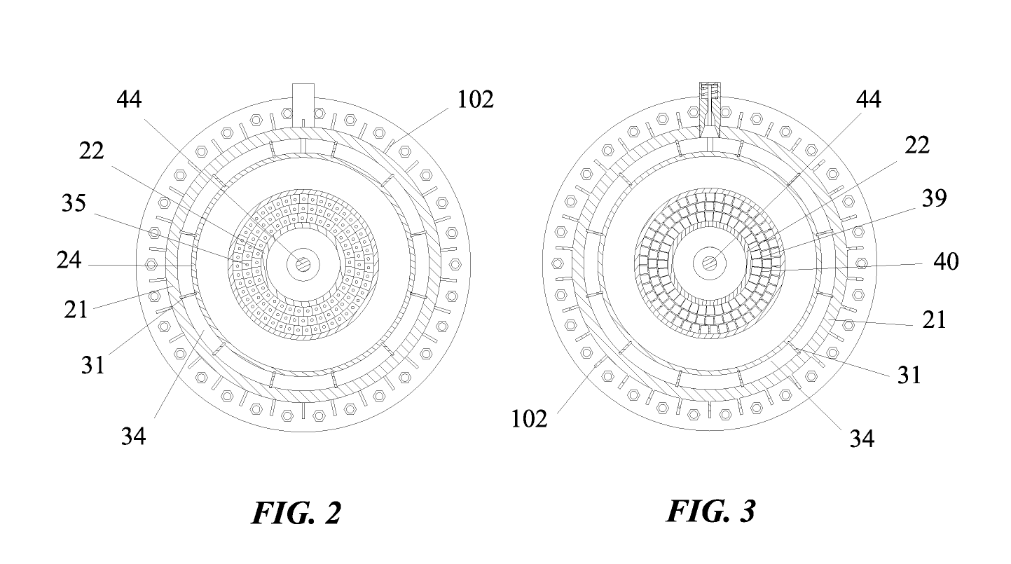

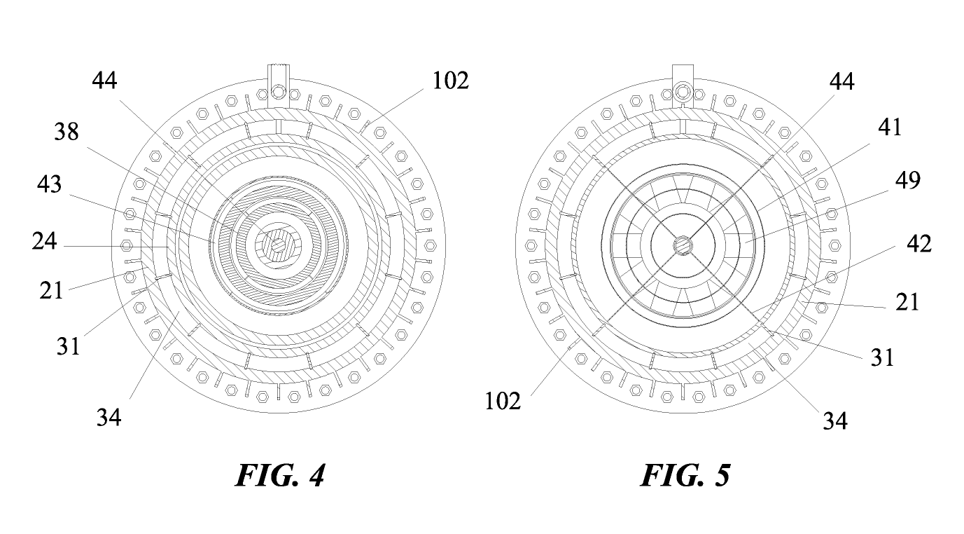

Accordingly, as shown in FIG. 1, which is a sectional view in a schematic representation of an exemplary embodiment of a closed-cycle hydro jet thruster (CCHJT) in accordance with the present invention, the CCHJT comprises: a non-rotating component fixedly attached to the chassis of a propelled vehicle and includes: a generally oval-shaped outer casing portion (21) having a longitudinal axis that is oriented in alignment with the direction of movement of the vehicle; two inner member portions (22, 23) fixedly attached against rotation to the outer casing portion; an intermediate body portion (24) fixedly attached against rotation to the outer casing portion and located intermediate of the outer casing portion and the inner member portions, with the opposing surfaces of the inner member portions and the intermediate body portion defining a central fluid flow passage (25) there in-between, and the opposing surfaces of the intermediate body portion and the outer casing portion defining a peripheral fluid flow passage (26) there in-between, the central fluid flow passage (25) has a fluid inflow end (27) and a fluid outflow end (28), and the peripheral fluid flow passage (26) has a fluid inflow end (29) and a fluid outflow end (30), with the fluid outflow end (28) of the central fluid flow passage merging with the fluid inflow end (29) of the peripheral fluid flow passage, and with the fluid outflow end (30) of the peripheral fluid flow passage merging with the fluid inflow end (27) of the central fluid flow passage to form a closed fluid circuit within the CCHJT; a plurality of radially-oriented planar members (31) positioned within the peripheral fluid flow passage (26), the radially-oriented planar members are fixedly attached against rotation to the outer casing portion (21) and to the intermediate body portion (24), and configured to divide the peripheral fluid flow passage (26) into a plurality of sub-passages (34), as shown in FIG. 2 which is a cross sectional view taken at the plane of line 2-2 in FIG. 1, with each radially-oriented planar member having a first end (32) partially extending within the fluid outflow end (28) of the central fluid flow passage and a second end (33) partially extending within the fluid inflow end (27) of the central fluid flow passage; a plurality of convergent nozzles (35) positioned within the central fluid flow passage (25) in proximity to its fluid inflow end (27) and fixedly attached against rotation to the inner member portion (22) and to the intermediate body portion (24), which is also shown in FIG. 2; two axially stacked sets of intersecting members (36,37) positioned within the central fluid flow passage (25) downstream of the convergent nozzles (35), and fixedly attached against rotation to the inner member portion (22) and to the intermediate body portion (24), with each of the said sets being configured to divide a part of the central fluid flow passage (25) into a plurality of sub-passages; and a set of concentric, fluid flow directing, annular members (38) positioned within the central fluid flow passage in-between the two axially stacked sets of intersecting members (36,37) and fixedly attached against rotation to the inner member portion (22) and to the intermediate body portion (24), with the said set of concentric, fluid flow directing, annular members being configured so that the opposing surfaces of its concentric annular members (38) along with the related parts of the surfaces of the inner member portion (22) and the intermediate body portion (24) define a plurality of concentric fluid flow passages (43), which is also shown in FIG. 4 which is a cross sectional view taken at the plane of line 4-4 in FIG. 1, with said passages (43) being configured to direct the flow of the working fluid during operation from the sub-passages defined by the first set of intersecting members (36) to the sub-passages defined by the second set of intersecting members (37); a drive shaft (44) supported for rotation in a given direction inside the outer casing (21) by an arrangement of bearings (47), having a longitudinal axis coinciding with the said longitudinal axis of the outer casing, provided with seal means (46), and extending to a drive-receiving end (45) located outside the casing; a rotor (48) secured for rotation with the drive shaft (44) and lying in a plane normal to the longitudinal axis of the drive shaft, said rotor includes a central disk, a plurality of circumferentially arranged blades (49) positioned for rotation within the said central fluid flow passage (25), and a circumferential, cylinder-shaped shroud (54) positioned around the outer edges of the blades and has an inner surface and an outer surface, with the inner surface of the shroud being attached to the outer edges of the blades ; a hydraulic fluid completely filling the said fluid flow passages and the free spaces enclosed within the outer casing (21); and a fluid pressure regulating system (not shown in this embodiment for simplicity).

As shown in FIG. 3, which is a cross sectional view taken at the plane of line 3-3 in FIG. 1, the first set of intersecting members (36) includes a plurality of radially-oriented planar members (39) intersecting with concentric annular cylinder members (40), with said intersecting members (36) being configured to divide a part of the central fluid flow passage into a plurality of sub-passages. And as also shown in FIG. 5, which is a cross sectional view taken at the plane of line 5-5 in FIG. 1, the second set of intersecting members (37) includes a number of radially-oriented planar members (42) intersecting with concentric annular cylinder members (41), with said intersecting members (37) configured to divide a part of the central fluid flow passage into a plurality of sub-passages.

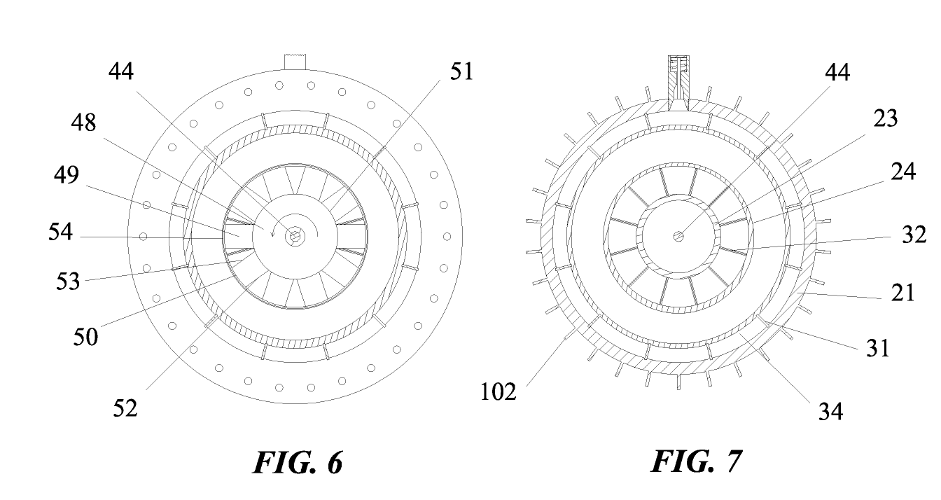

As shown in FIG. 6, which is a cross sectional view taken at the plane of line 6-6 in FIG. 1, the CCHJT rotor (48) includes 10 blades (49), each blade has an inner edge (51) attached to a central disk, an outer edge (50), a leading edge (52), and a trailing edge (53), with the outer edges (50) of the blades being attached to the circumferential, shroud (54) positioned around them, as described herein above. And as shown in FIG. 7, which is a cross sectional view taken at the plane of line 7-7 in FIG. 1, as well as in FIGS. 1-6, the outer surface of the outer casing (21) is provided with a plurality of cooling ribs (102) for dissipating the heat generated within the CCHJT during operation.

In operation, the rotating blades (49) will compress and displace the hydraulic fluid downstream of the blades, and create a low-pressure zone upstream of the blades leading to suction of the hydraulic fluid towards the blades (49). The developed pressure gradient between the upstream and downstream surfaces of the blades (49), along with the displacement of the working fluid downstream of the blades will lead to the generation of linear force acting in a direction perpendicular to the plane of rotation of the blades, with said generated linear force being used directly for propelling and/or lifting a movable vehicle. As the blades are configured to operate at relatively low angles of attack, so most of the generated linear force by the rotating blades will be due to the pressure gradient between the upstream and downstream surfaces of the blades, with only a small fraction of that force being due to the displacement of the hydraulic fluid downstream of the blades.

The portion of the central fluid flow passage (25) downstream of the blades is configured to allow for merging of the separate sub-flows of hydraulic fluid displaced downstream of the blades into one common flow having homogenous hydrostatic pressure and velocity, followed by splitting the flow into a number of sub-flows each directed towards one of the peripheral sub-passages (34) confined between the outer casing (21), the intermediate body portion (24), and the radially-oriented planar members (31), with the peripheral sub-passages being configured to direct the flow of the working fluid from the downstream end (28) of the central fluid flow passage to the upstream end (27) of the central fluid flow passage. On reaching the upstream end of the central fluid flow passage, each of the fluid sub-flows will be directed through a number of the nozzles (35) positioned within the central fluid flow passage, wherein the working fluid accelerates with partial conversion of its hydrostatic energy into kinetic energy. The accelerated working fluid will be then directed through the sub-passages formed in-between the first set of intersecting members (36), followed by directing the sub-flows through the sub-passages formed in-between the concentric annular members (38) towards the sub-passages formed in-between the second set of intersecting members (37), with the said sub-passages of the two sets of intersecting members (36, 37) being configured to suddenly expand the working fluid flowing out of the convergent nozzles within them. The sudden expansion of the working fluid leads to conversion of a part of its kinetic energy into heat energy, with said heat energy being eventually dissipated through the outer casing (21) of the CCHJT to the surrounding atmosphere.

The portion of the central fluid flow passage (25) upstream of the blades is configured to first align the flow of the decelerated working fluid flowing out of the sub-passages of the second set of intersecting members (37), and then to direct the flow of the working fluid towards the suction surfaces of the rotating blades (49) where the working fluid is re-accelerated by the effect of the low pressure zone created upstream of the blades during operation.

The thrust, or lift, force generated by the CCHJT's rotor (48) is directly transmitted to the CCHJT's casing (21) through a thrust bearing arrangement (47), with non-limiting examples of thrust bearing arrangements for use include fixed-geometry thrust bearings; and tilting pad thrust bearings.

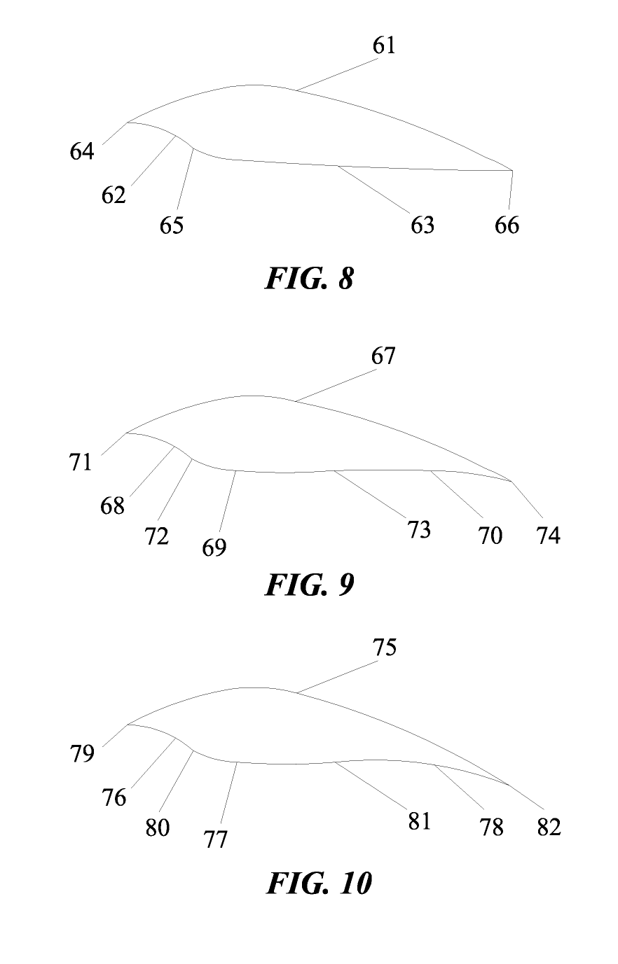

FIG. 8 is a cross-sectional profile view in a schematic representation of a preferred embodiment of a blade for use in the CCHJT's rotor, in accordance with the present invention.

As shown in this embodiment, the blade has a suction surface (61) and a displacing surface, with the displacing surface being geometrically formed of two successive merging portions (62, 63), a first portion (62) having a leading end (64), coinciding with the leading edge of the blade, and a trailing end (65) and a second portion (63) having a leading end (65) and a trailing end (66) coinciding with the trailing edge of the blade, the first portion (62) extends from the leading edge of the blade (64) to the leading end (65) of the second portion (63) and is generally concave when viewed in cross-sectional profile, and the second portion (63) extends from the trailing end (65) of the first portion to the trailing edge (66) of the blade and is generally convex when viewed in cross-sectional profile. In this embodiment, the blade has a beak-like leading edge (64) when viewed in cross-sectional profile, to disrupt the eddies formed due to the interaction between the successive blades during operation.

FIG. 9 is a cross-sectional profile view in a schematic representation of another preferred embodiment of a blade for use in the CCHJT's rotor, in accordance with the present invention.

As shown in this embodiment, the blade has a suction surface (67) and a displacing surface, with the displacing surface being geometrically formed of three successive merging portions (68, 69, 70), a first portion (68) having a leading end (71), coinciding with the leading edge of the blade, and a trailing end (72), a second portion (69) having a leading end (72), and a trailing end (73), and a third portion (70) having a leading end (73) and a trailing end (74) coinciding with the trailing edge of the blade, the first portion (68) extends from the leading edge of the blade (71) to the leading end (72) of the second portion and is generally concave when viewed in cross-sectional profile, the second portion (69) extends from the leading end (72) of the second portion to the leading end (73) of the third portion and is generally convex when viewed in cross-sectional profile, and the third portion (70) extends from the trailing end (73) of the second portion to the trailing edge (74) of the blade and is generally concave when viewed in cross-sectional profile. Also in this embodiment, the blade has a beak-like leading edge (71) when viewed in cross-sectional profile, to disrupt the eddies formed due to the interaction between the successive blades during operation.

FIG. 10 is a cross-sectional profile view in a schematic representation of another preferred embodiment of a blade for use in the CCHJT's rotor, in accordance with the present invention.

As shown in this embodiment, the blade has a suction surface (75) and a displacing surface, with the displacing surface being geometrically formed of three successive merging portions (76, 77, 78), a first portion (76) having a leading end (79), coinciding with the leading edge of the blade, and a trailing end (80), a second portion (77) having a leading end (80), and a trailing end (81), and a third portion (78) having a leading end (81) and a trailing end (82) coinciding with the trailing edge of the blade, the first portion (76) extends from the leading edge of the blade (79) to the leading end (80) of the second portion and is generally concave when viewed in cross-sectional profile, the second portion (77) extends from the leading end (80) of the second portion to the leading end (81) of the third portion and is generally convex when viewed in cross-sectional profile, and the third portion (78) extends from the trailing end (81) of the second portion to the trailing edge (82) of the blade and is generally concave when viewed in cross-sectional profile. In this embodiment, the blade has a beak-like leading edge (79) when viewed in cross-sectional profile, to disrupt the eddies formed due to the interaction between the successive blades during operation, and downstream curved trailing edge (82) when viewed in cross-sectional profile, to increase the hydrostatic pressure of the working fluid downstream the blades during operation, and hence improving the blade's overall performance.

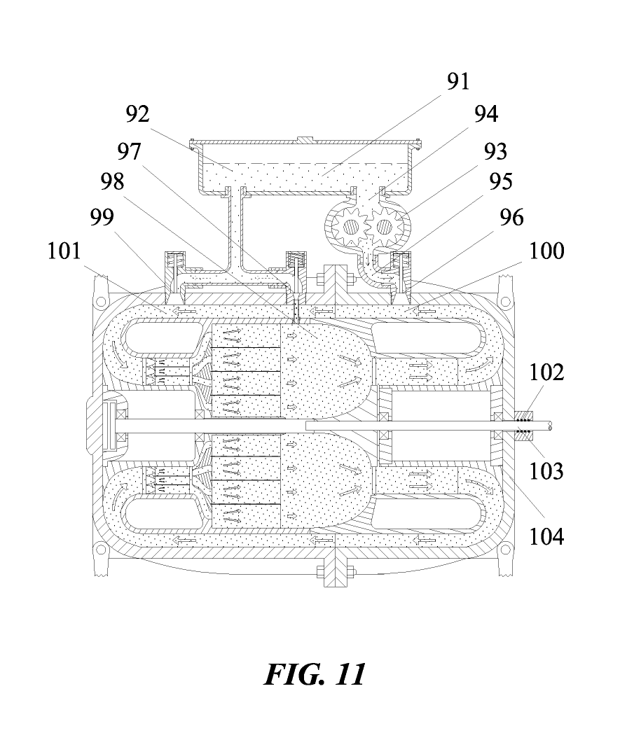

FIG. 11 is a sectional view in a schematic representation of another exemplary embodiment of a CCHJT, showing the components of a preferred embodiment of a fluid pressure regulating system, in accordance with the present invention.

In this embodiment, the fluid pressure regulating system comprises a fluid reservoir (91) partially filled with a hydraulic fluid (92); a hydraulic pump (93) having an inlet (94) and an outlet (95), with the hydraulic pump inlet (94) being fluidly coupled to the fluid reservoir (91); a unidirectional valve (96) having an inlet port fluidly coupled to the hydraulic pump outlet (95) and an outlet fluidly coupled to a fluid flow passage (100) defined within the CCHJT, and configured to permit fluid flow only in one direction from the hydraulic pump outlet (95) to the fluid flow passage (100) defined within the CCHJT; a spring-loaded safety relief valve (97) having an inlet port fluidly coupled to a fluid flow passage (98) defined within the CCHJT and an outlet port fluidly coupled to the fluid reservoir (91), and configured to permit fluid flow only in one direction from the fluid flow passage (98) defined within the CCHJT to the fluid reservoir (91) once a first predetermined hydrostatic pressure is reached within the CCHJT; and a spring-loaded suction valve (99) having an inlet port fluidly coupled to the fluid reservoir (91) and an outlet port fluidly coupled to a fluid flow passage (101) defined within the CCHJT, and configured to permit fluid flow only in one direction from the fluid reservoir (91) to the fluid flow passage (101) defined within the CCHJT once a second predetermined hydrostatic pressure is reached within the CCHJT.

On starting the CCHJT, the hydraulic pump (93) is first operated to increase the hydrostatic pressure within the CCHJT's fluid flow passages until a predetermined hydrostatic pressure is reached, with said predetermined pressure being selected to suffice preventing the formation of cavitations on the upstream suction surfaces of the blades at the maximum blades' operating rotational speed. Then, the hydraulic pump (93) is stopped. The operation of the hydraulic pump (93) is either controlled manually, or by a pressure-sensor actuated control system, which is not shown in the drawings for simplicity.

After the said predetermined hydrostatic pressure is reached, and the CCHJT is turned on, as the operation of the CCHJT will be associated with heating up of the hydraulic fluid leading to its expansion, which, if not relieved, will lead to marked increase in the hydrostatic pressure of the fluid within the CCHJT's casing, so, to avoid this, the spring-loaded safety relief valve (97) is provided and configured to allow for the release of some of the hydraulic fluid from the CCHJT's fluid flow passages to the fluid reservoir (91), once a predetermined hydrostatic pressure is reached within the fluid flow passages, to prevent the increase of pressure within the CCHJT's casing above its safe design levels.

When not in operation, as the cooling of the hydraulic fluid will lead to a proportional decrease in its volume, so, a spring-loaded suction valve (99) is provided and configured to allow for the flow of the hydraulic fluid from the fluid reservoir (91) to the CCHJT's fluid flow passages once another predetermined hydrostatic pressure is reached within the fluid flow passages, to prevent the ingression of air into the CCHJT's fluid flow passages through the seal means (102) provided between the CCHJT's drive shaft (103) and casing (104), to avoid deteriorating the efficiency of the CCHJT during operation.

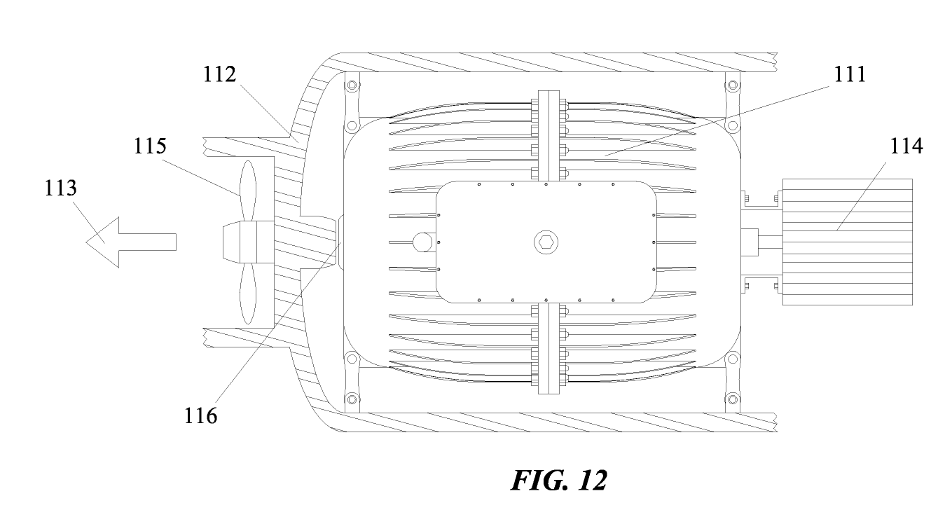

FIG. 12 is a schematic representation of an exemplary embodiment of a CCHJT-driving mechanism layout within a driven vehicle, in accordance with the present invention, wherein the CCHJT (111) is fixedly attached to the chassis (112) of the driven vehicle, with its longitudinal axis oriented in alignment with the direction of intended movement (113) of the vehicle. The CCHJT's driving torque is provided by an electric motor (114), with a cooling fan (115) being provided for augmented cooling of the CCHJT during operation. The thrust force generated by the CCHJT (111) during operation is directly transmitted to the chassis (112) of the driven vehicle through a knob (116) at the leading end of the CCHJT.

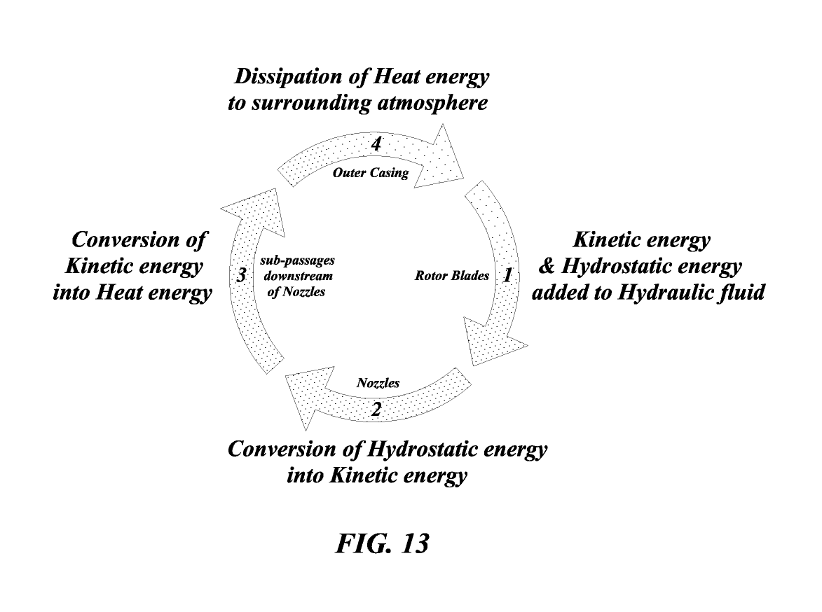

FIG. 13 is an illustrative representation of the fluid flow cycle within a CCHJT, showing the energy added to, and discharged from, the hydraulic fluid during operation, in accordance with the present invention.

In operation, the hydraulic fluid will be compressed and displaced downstream the rotating blades, with kinetic and hydrostatic energy added to it (Step 1), followed by directing the fluid flow through convergent nozzles wherein the fluid accelerates, with conversion of a portion of its hydrostatic energy into kinetic energy (Step 2). The fluid flow is then directed into the sub-passages downstream of the nozzles wherein the fluid suddenly expand, with conversion of a portion of its kinetic energy into heat energy (Step 3), which is followed by dissipating the said heat energy to surrounding atmosphere (Step 4).

The various components of the CCHJT are configured so that all the energy added to the working fluid in Step 1 will be either exhausted in the generation of reaction forces on the curved parts of the CCHJT's fluid flow passages, or will be converted to heat energy, which will eventually dissipate to surrounding atmosphere.

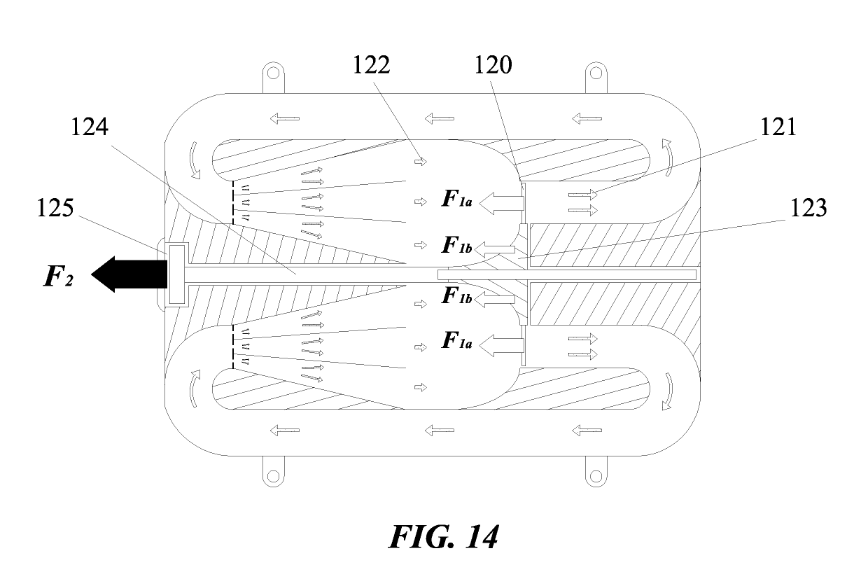

FIG. 14 is an illustrative representation of the forces generated on the rotating components of an exemplary embodiment of a CCHJT during operation, in accordance with the present invention.

In operation, the rotating blades (120) will compress and displace the hydraulic fluid downstream of the blades (121), and create a low-pressure zone upstream of the blades leading to suction of the hydraulic fluid (122) towards the blades (120). The developed pressure gradient between the upstream and downstream surfaces of the blades (120), along with the displacement of the working fluid downstream of the blades will lead to the generation of linear force F₁ₐ acting in a direction perpendicular to the plane of rotation of the blades. The suction of the hydraulic fluid (122) towards the blades (120) and compression of the hydraulic fluid downstream the blades (120) will also create a pressure gradient between the upstream and downstream surfaces of the rotor's disc (123) leading to the generation of another linear force F_{1b} acting in a direction perpendicular to the plane of rotation of the blades. The resultant of the two forces F₁ₐ and F_{1b} will be transmitted through the drive shaft (124) and thrust bearings (125) to the CCHJT casing, and will be used directly for propelling and/or lifting the movable vehicle.

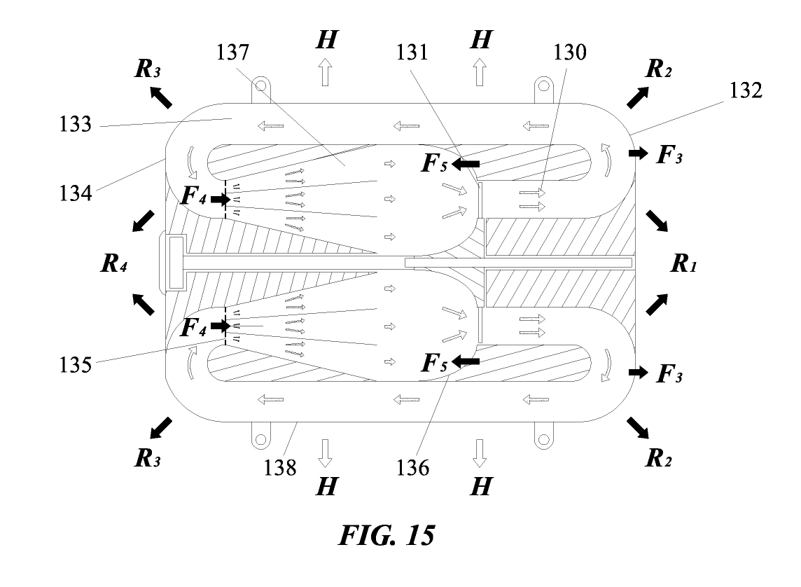

FIG. 15 is an illustrative representation of the forces generated on the non-rotating components of an exemplary embodiment of a CCHJT during operation, in accordance with the present invention.

In operation, the hydraulic fluid (130) compressed and displaced downstream of the blades (131) will be deflected by the U-shaped curved part (132) of the fluid flow passage downstream of the blades, which will generate reaction forces R₁ and R₂ acting on this part of the fluid flow passage. The hydraulic fluid will be directed through the peripheral fluid flow sub-passages (133) to the U-shaped curved part (134) of the fluid flow passage upstream of the blades, which will generate reaction forces R₃ and R₄ acting on this part of the fluid flow passage, which will neutralize the reaction forces R₁ and R₂ generated on the curved parts of the fluid flow passage downstream of the blades. However, as the flow of the hydraulic fluid within these portions of the fluid flow passage will lead to partial losses in the pressure head of the hydraulic fluid, so, the hydrostatic pressure of the hydraulic fluid acting on the downstream U-shaped curved part (132) of the fluid flow passage will be higher than the hydrostatic pressure of the hydraulic fluid acting on the upstream U-shaped curved part (134) of the fluid flow passage, which will create a pressure gradient between the two curved parts (132, 134) of the fluid flow passage leading to the generation of a linear force F₃ acting in a direction opposite to the intended direction of movement of the propelled and/or lifted vehicle.

The deflected working fluid will then flow through the convergent nozzles (135) wherein the working fluid accelerates with partial conversion of its hydrostatic pressure into kinetic pressure. This will create a pressure gradient between the upstream and downstream ends of the nozzles (135) leading to the generation of another linear force F₄ acting in a direction opposite to the intended direction of movement of the propelled and/or lifted vehicle.

In addition, the suction of the working fluid towards the blades (131) will create a low-pressure zone on the surface of the intermediate body portion (136) next to the blades (131), leading to the generation of a linear force F₅ acting in a direction coinciding with the intended direction of movement of the propelled and/or lifted vehicle. The sudden expansion of the accelerated working fluid within the sub-passages (137) downstream of the nozzles (135) will lead to conversion of a portion of its kinetic energy into heat energy H, which will eventually dissipate to surrounding atmosphere through the outer casing (138) of the CCHJT.

The net thrust and/or lift force generated by the CCHJT, which will be transmitted to the chassis of the propelled vehicle, depends on the magnitude of each of the above-mentioned forces, which will depend on the design specifications of each of the CCHJT components, and is to be determined experimentally for each design.

Further objectives and advantages of the present invention will be apparent to those skilled in the art from the detailed description of the disclosed invention. The present discussion of illustrative embodiments is not intended to limit the spirit and scope of the invention beyond that specified by the claims presented hereafter.

What is claimed is:

1. A closed-cycle hydro-jet thruster which is used for converting therein the torque provided by a prime mover, or an electric motor, into direct thrust and/or lift force, with said generated thrust and/or lift force being used directly for propelling and/or lifting a movable vehicle, and with the said closed-cycle hydro-jet thruster comprising: a non-rotating component that is configured to define at least one closed-circuit fluid flow passage therewithin, and that includes at least one set of convergent nozzles, at least one set of intersecting members configured to divide a part of the said at least one fluid flow passage into a number of sub-passages, and a hydraulic fluid completely filling the said at least one closed-circuit fluid flow passage; and a rotating component that includes a rotor having a plurality of circumferentially arranged blades, with the said blades positioned for rotation within the said at least one closed-circuit fluid flow passage, oriented to rotate in a plane normal to the direction in which force is generated during operation, and configured to operate at low angles of attack, the said at least one set of convergent nozzles positioned downstream of the said blades and configured to accelerate the fluid flowing through them during operation, and the said at least one set of intersecting members positioned downstream of the said convergent nozzles, with the said sub-passages defined in-between the said intersecting members being configured to suddenly expand the fluid flowing out of the said convergent nozzles during operation.

2. A closed-cycle hydro-jet thruster which is used for converting therein the torque provided by a prime mover, or an electric motor, into direct thrust and/or lift force, with said generated thrust and/or lift force being used directly for propelling and/or lifting a movable vehicle, and with the said closed-cycle hydro-jet thruster comprising:
A non-rotating component fixedly attached to the chassis of the said movable vehicle and including : a generally oval-shaped outer casing portion having a longitudinal axis that is oriented in alignment with a direction of movement of the said vehicle; at least two inner member portions fixedly attached against rotation to the outer casing portion; at least one intermediate body portion fixedly attached against rotation to the outer casing portion and located intermediate of the outer casing portion and the at least two inner member portions, with the opposing surfaces of the at least two inner member portions and the at least one intermediate body portion defining a central fluid flow passage there in-between, and the opposing surfaces of the at least one intermediate body portion and the outer casing portion defining a peripheral fluid flow passage there in-between, the central fluid flow passage has a fluid inflow end and a fluid outflow end, and the peripheral fluid flow passage has a fluid inflow end and a fluid outflow end, with the fluid outflow end of the central fluid flow passage merging with the fluid inflow end of the peripheral fluid flow passage, and with the fluid outflow end of the peripheral fluid flow passage merging with the fluid inflow end of the central fluid flow passage to form a closed fluid circuit within the thruster; a plurality of radially-oriented planar members positioned within the peripheral fluid flow passage, the radially-oriented planar members are fixedly attached against rotation to at least one of the said portions of the non-rotating component that define the peripheral fluid flow passage between them, and configured to divide the peripheral fluid flow passage into a plurality of sub-passages, each radially-oriented planar member has a first end partially extending within the said fluid outflow end of the central fluid flow passage and a second end partially extending within the said fluid inflow end of the central fluid flow passage; a plurality of convergent nozzles positioned within the central fluid flow passage in proximity to the fluid inflow end of the said passage and fixedly attached against rotation to at least one of the said portions of the non-rotating component that define the central fluid flow passage between them; and at least one set of intersecting members positioned within the central fluid flow passage downstream of the said convergent nozzles, the at least one set of intersecting members is fixedly attached against rotation to at least one of the said portions of the non-rotating component that define the central fluid flow passage between them, includes a plurality of radially-oriented planar members intersecting with at least one annular cylinder member, and is configured to divide a part of the central fluid flow passage downstream of the said convergent nozzles into a plurality of sub-passages;
a drive shaft supported for rotation in a given direction inside the outer casing by an arrangement of bearings and having a longitudinal axis coinciding with the said longitudinal axis of the outer casing;
a rotor secured for rotation with the drive shaft and lying in a plane normal to the longitudinal axis of the drive shaft, said rotor includes at least one central disk and a plurality of circumferentially arranged blades, each blade has an inner edge attached to the central disk, an outer edge, a leading edge, and a trailing edge, with said blades being positioned for rotation within the said central fluid flow passage;
a hydraulic fluid completely filling the said fluid flow passages and the free spaces enclosed within the said outer casing portion of the non-rotating component; and
a fluid pressure regulating system.

3. The closed-cycle hydro-jet thruster of claim 2, wherein the said at least one set of intersecting members positioned downstream of the convergent nozzles includes a plurality of radially-oriented planar members intersecting with more than one concentric annular cylinder members, with the at least one set of intersecting members being configured to divide a part of the central fluid flow passage downstream of the said convergent nozzles into a plurality of sub-passages.

4. The closed-cycle hydro-jet thruster of claim 2, wherein the said at least one set of intersecting members positioned downstream of the convergent nozzles comprises two axially stacked sets of intersecting members: a first set of intersecting members and a second set of intersecting members, with the second set of intersecting members positioned downstream of the first set of intersecting members, and with the said non-rotating component of the thruster further includes a set of concentric, fluid flow directing, annular members positioned within the central fluid flow passage in-between the said two axially stacked sets of intersecting members and fixedly attached against rotation to at least one of the said portions of the non-rotating component that define the central fluid flow passage between them, each of the said sets of intersecting members is fixedly attached against rotation to at least one of the said portions of the non-rotating component that define the central fluid flow passage between them, includes a plurality of radially-oriented planar members intersecting with at least one annular cylinder member, and is configured to divide part of the central fluid flow passage downstream of the convergent nozzles into a plurality of sub-passages, the said set of concentric, fluid flow directing, annular members is configured so that the opposing surfaces of its concentric annular members along with the related parts of the surfaces of the at least one intermediate body portion and the at least two inner member portions define a plurality of concentric fluid flow passages for directing the flow of a working fluid from the said sub-passages defined by the first set of intersecting members to the said sub-passages defined by the second set of intersecting members.

5. The closed-cycle hydro-jet thruster of claim 4, wherein at least one of the two axially stacked sets of intersecting members positioned downstream of the convergent nozzles includes a plurality of radially-oriented planar members intersecting with more than one concentric annular cylinder members, with the at least one of the two axially stacked sets of intersecting members being configured to divide a part of the central fluid flow passage downstream of the convergent nozzles into a plurality of sub-passages.

6. The closed-cycle hydro-jet thruster of claim 2, wherein the number of the said blades of the rotor ranges preferably between 6 and 72 blades, with an intervening gap being provided between each two successive blades.

7. The closed-cycle hydro-jet thruster of claim 6, wherein with the ratio between the mean width of each of the said intervening gaps and the mean Chord length of each of the said blades lies preferably anywhere within a range between 0.25:1 and 2:1, and more preferably between 0.5:1 and 1:1.

8. The closed-cycle hydro-jet thruster of claim 2, wherein the successive parts of each of the said blades of the rotor are configured to have the same angle of attack, with the said angle of attack lying preferably within a range extending between 2 degrees and 14 degrees, and more preferably within a range extending between 4 degrees and 10 degrees.

9. The closed-cycle hydro-jet thruster of claim 2, wherein the successive parts of each of the said blades of the rotor are configured to have gradually increasing angles of attack from the blade's outer edge to the blade's inner edge, with the said angles of attack being selected from a range of angles extending preferably between 2 degrees and 14 degrees and more preferably between 4 degrees and 10 degrees.

10. The closed-cycle hydro-jet thruster of claim 2, wherein each of the said blades of the rotor has a suction surface and a displacing surface, with the displacing surface being geometrically formed of two successive merging portions, a first portion having a leading end coinciding with the leading edge of the blade and a trailing end and a second portion having a leading end and a trailing end coinciding with the trailing edge of the blade, the said first portion extends from the said leading edge of the blade to the said leading end of the second portion and is generally concave when viewed in cross-sectional profile, and the said second portion extends from the said trailing end of the first portion to the said trailing edge of the blade and is generally convex when viewed in cross-sectional profile.

11. The closed-cycle hydro-jet thruster of claim 2, wherein each of the said blades of the rotor has a suction surface and a displacing surface, with the displacing surface being geometrically formed of three successive merging portions, a first portion having a leading end coinciding with the leading edge of the blade and a trailing end, a second portion having a leading end and a trailing end, and a third portion having a leading end and a trailing end coinciding with the trailing edge of the blade, the said first portion extends from the said leading edge of the blade to the said leading end of the second portion and is generally concave when viewed in cross-sectional profile, the said second portion extends from the said trailing end of the first portion to the said leading end of the third portion and is generally convex when viewed in cross-sectional profile, and the said third portion extends from the said trailing end of the second portion to the said trailing edge of the blade and is generally concave when viewed in cross-sectional profile.

12. The closed-cycle hydro-jet thruster of claim 2, wherein each of the said blades of the rotor has a beak-like leading edge when viewed in cross-sectional profile.

13. The closed-cycle hydro-jet thruster of claim 2, wherein each of the said blades of the rotor has a downstream curved trailing edge when viewed in cross-sectional profile.

14. The closed-cycle hydro-jet thruster of claim 2, with the said rotor further including a circumferential, cylinder-shaped shroud positioned around the outer edges of the said rotor blades and has an inner surface and an outer surface, with the inner surface of the said shroud being attached to the outer edges of the said rotor blades.

15. The closed-cycle hydro-jet thruster of claim 2, wherein the said drive shaft extends to a drive-receiving end located outside the said outer casing, through which driving torque is supplied during operation.

16. The closed-cycle hydro-jet thruster of claim 2, wherein the said drive shaft is geared to an intermediate shaft, with the said intermediate shaft extending to a drive-receiving end located outside the said outer casing, through which driving torque is supplied during operation.

17. The closed-cycle hydro-jet thruster of claim 2, wherein the said fluid pressure regulating system comprises a fluid reservoir partially filled with a hydraulic fluid; a hydraulic pump having an inlet and an outlet, with the said hydraulic pump inlet being fluidly coupled to the said fluid reservoir; a unidirectional valve having an inlet port fluidly coupled to the said hydraulic pump outlet and an outlet fluidly coupled to at least one of the said fluid flow passages defined within the CCHJT, and configured to permit fluid flow only in one direction from the hydraulic pump outlet to the said at least one of the fluid flow passages defined within the CCHJT; a spring-loaded safety relief valve having an inlet port fluidly coupled to at least one of the said fluid flow passages defined within the CCHJT and an outlet port fluidly coupled to the said fluid reservoir, and configured to permit fluid flow only in one direction from the said at least one of the said fluid flow passages defined within the CCHJT to the said fluid reservoir once a first predetermined hydrostatic pressure is reached within the CCHJT; and a spring-loaded suction valve having an inlet port fluidly coupled to the said fluid reservoir and an outlet port fluidly coupled to at least one of the said fluid flow passages defined within the CCHJT, and configured to permit fluid flow only in one direction from the said fluid reservoir to the said at least one of the said fluid flow passages defined within the CCHJT once a second predetermined hydrostatic pressure is reached within the CCHJT.

18. The closed-cycle hydro-jet thruster of claim 17, wherein the said fluid reservoir is completely sealed from surrounding atmosphere.

19. The closed-cycle hydro-jet thruster of claim 17, wherein the said fluid reservoir has at least one passage for connecting it with surrounding ambient air.

20. The closed-cycle hydro-jet thruster of claim 17, wherein the said fluid reservoir has at least one spring-loaded safety relief valve having an inlet port fluidly coupled to a gas filled space confined within the said fluid reservoir and an outlet port fluidly coupled to surrounding ambient air, and configured to permit gas flow only in one direction from the said fluid reservoir to surrounding ambient air once a first predetermined pressure is reached within the said fluid reservoir; and at least one spring-loaded suction valve, having an inlet port fluidly coupled to surrounding ambient air and an outlet valve fluidly coupled to a gas filled space confined within the said fluid reservoir, and configured to permit gas flow only in one direction from the surrounding ambient air to the said fluid reservoir once a second predetermined pressure is reached within the said fluid reservoir.

21. The closed-cycle hydro-jet thruster of claim 2, wherein at least one arrangement for dissipating the heat generated within the said CCHJT during operation is provided.

22. The closed-cycle hydro-jet thruster of claim 21, wherein the said arrangement provided for dissipating the heat generated within the CCHJT during operation includes a plurality of cooling ribs provided on the outer surface of the said outer casing portion of the non-rotating component of the CCHJT.

23. The closed-cycle hydro-jet thruster of claim 21, wherein the said arrangement provided for dissipating the heat generated within the CCHJT during operation includes a forced air or a forced fluid cooling mechanism.

24. The closed-cycle hydro-jet thruster of claim 21, wherein the said arrangement provided for dissipating the heat generated within the CCHJT during operation is configured to employ the discharged heat in heating a fluid medium flowing around the CCHJT.

25. The closed-cycle hydro-jet thruster of claim 2, wherein the thrust, or lift, force generated by the said blades of the rotor during operation is transmitted to the said non-rotating component of the CCHJT through at least one thrust bearing arrangement.

26. The closed-cycle hydro-jet thruster of claim 2, wherein the said torque provided by the said prime mover, or electric motor, is transmitted to the said drive shaft through a gear train arrangement.

27. The closed-cycle hydro-jet thruster of claim 2, wherein the said non-rotating component of the thruster is fixedly attached against rotation to the main frame of the said movable vehicle.

28. The closed-cycle hydro-jet thruster of claim 2, wherein the said non-rotating component of the thruster is pivotally attached to the main frame of the said movable vehicle, with at least one mechanism for changing the direction in which the developed thrust and/or lift force is applied during operation being provided.

29. In a closed-cycle hydro-jet thruster having: a non-rotating component that is configured to define at least one closed-circuit fluid flow passage therewithin, and that includes at least one set of convergent nozzles, at least one set of intersecting members configured to divide a part of the said at least one fluid flow passage into a number of sub-passages, and a hydraulic fluid completely filling the said at least one closed-circuit fluid flow passage; and a rotating component that includes a rotor having a plurality of circumferentially arranged blades positioned for rotation within the said at least one closed-circuit fluid flow passage and configured to operate at low angles of attack, an operating cycle that includes the steps of:
a. compressing and displacing the said hydraulic fluid downstream of the said blades;
b. accelerating the said compressed, displaced working fluid by flowing it through the said at least one set of convergent nozzles; and
c. suddenly expanding the said accelerated working fluid by flowing it through the said sub-passages defined in-between the said at least one set of intersecting members.

30. The operating cycle of claim 29, which further includes the step of:
d. actively dissipating the heat generated within the closed-cycle hydro-jet thruster during operation to a surrounding atmosphere.
